(19) United States
(12) Patent Application Publication
(10) Pub. No.: US 2008/0182604 A1
(43) Pub. Date: Jul. 31, 2008

(54) COMMUNICATIONS APPARATUS, SERVER APPARATUS, AND INFORMATION PROCESSING SYSTEM

(75) Inventors: Hideto Kihara, Kawasaki (JP); Kazuki Matsui, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/020,920

(22) Filed: Jan. 28, 2008

(30) Foreign Application Priority Data
Jan. 31, 2007 (JP) 2007-020531

(51) Int. Cl. H04Q 7/20

(52) U.S. Cl. 455/466

(57) ABSTRACT

According to an aspect of the invention, a communications apparatus for transmitting one or more items of information to a processing system which performs predetermined processes using the information comprises: a storage part storing the items of information; a transmission designation part designating the transmission; a transmission part waiting and storing the items of information for an information wait time, and collectively transmitting the stored items of the information to the processing system; a wait time determining part obtaining both a first time required for collectively transmitting the stored items and a second time required for individually transmitting the items, comparing the first time with the second time, and thereby setting a shorter of the two times as the information wait time in the transmission part.

### CROSS-REFERENCE TO RELATED APPLICATIONS

This application is related to and claims priority under 35 U.S.C §119(a) on Japanese Patent Application No. 2007-20531 filed on Jan. 31, 2007 in the Japan Patent Office, and incorporated by reference herein.

### BACKGROUND OF THE INVENTION

1. Field of the Invention

The present invention relates to a communications apparatus for transmitting information to a server apparatus, the server apparatus for receiving the information, performing a predefined process on the information, sending back to the communications apparatus a results response expressing the results of the predefined process, and an information processing system including such a communications apparatus or server apparatus.

2. Description of the Related Art

In recent years, a mobile communications apparatus represented by a mobile telephone is used to wirelessly access a predetermined server apparatus perform things such as exchanging information with the server apparatus. Therefore, various technological innovations were proposed regarding the exchange of such information.

For example, in Japanese Unexamined Patent Application Publication No. 2006-163780, the following technology was disclosed.

First, an application program contained in a communications apparatus is activated for downloading desired contents from a server apparatus by way of wireless communications. Then, the desired contents are specified using the application program, a download request is issued for the contents using the application program, and the request is transmitted to the server apparatus. The application program transmits to the server apparatus the type of the application program along with the contents of the download request. After the server apparatus converts the contents into a form that is suitable to the type of application program from which the request was received, the server apparatus sends the contents to the communications apparatus that issued the download request.

In addition, the following technology was disclosed in Japanese Unexamined Patent Application Publication No. 2001-22631.

When the contents requested by a communications apparatus include several files, the server apparatus collectively transmits those files to the communications apparatus.

Because communications between a communications apparatus and a server apparatus can be performed smoothly by using these technologies, communication efficiency is improved.

### SUMMARY

According to an aspect of an embodiment, a communications apparatus for transmitting information to a processing system which performs a predetermined process using the information, includes:
a storage part which is provided with information and stores the information every time the information is provided;
a transmission designation part which designates transmission of the information;

a transmission part which, upon receiving a designation of transmission from the transmission designation part, waits only for information wait time, then collectively transmits the information stored up during the information wait time to the processing system; and
a wait time determining part which obtains a first time required for collectively transmitting both the information stored at the time designated by the transmission designation part and the information stored while waiting for the information wait time, and a second time required for individually transmitting both the information stored at the time designated by the transmission designation part and the information provided to the storage part afterwards without waiting for the information wait time in order to transmit all information to the processing system. The wait time determining part compares the first time with the second time, and thereby sets a shorter time as the information wait time in the transmission part.

### BRIEF DESCRIPTION OF THE DRAWINGS

FIG. 1 is a schematic view of an embodiment of the information processing system according to the present invention.

FIG. 2 is an external perspective view of a mobile telephone 100.

FIG. 3 is an internal block diagram of a mobile telephone 100.

FIG. 4 is a functional block diagram focusing on the function of the information processing system 10 shown in FIG. 1, which function exchanges requests or responses between the mobile telephone 100 and the relay server 200.

FIG. 5 is an explanatory diagram which explains the calculation of the request wait time.

FIG. 6 is a schematic view showing an example of a merged request.

FIG. 7 is a schematic view showing an example of a merged response.

FIGS. 8A and 8B is a figure showing an example of a new merged request.

### BRIEF DESCRIPTION OF THE EMBODIMENTS

The embodiments of the present invention are explained below while referring to the figures.

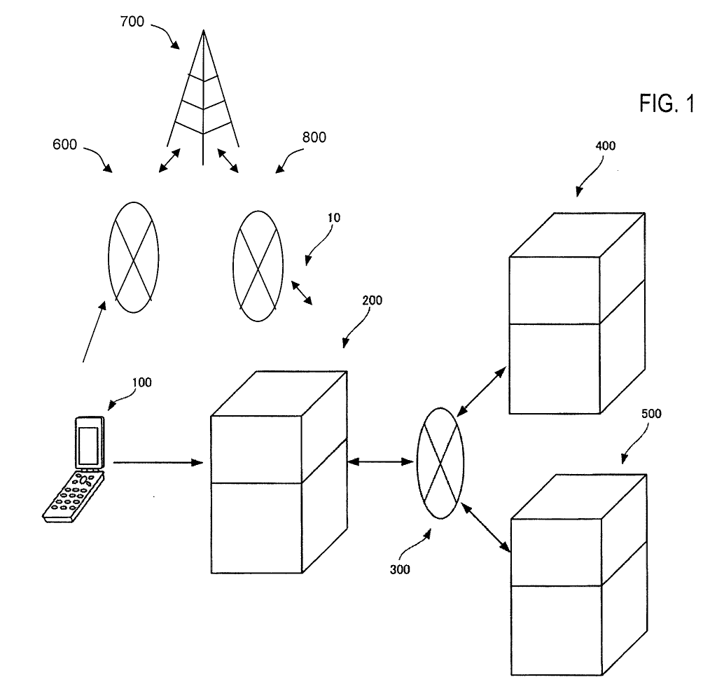

FIG. 1 is a schematic view of an embodiment of an information processing system according to the present invention.

The information processing system 10 shown in FIG. 1 includes a mobile telephone 100, a relay server 200, a network 300, a work server 400, an operations management server 500, a wireless network 600, a base station 700, and a network 800. The information processing system 10 exchanges various types of information between the mobile telephone 100 and the servers (the work server 400 or the operations management server 500) by way of relay from the relay server 200. The relay server 200 actually accesses a variety of mobile apparatuses able to communicate wirelessly such as mobile telephones or mobile computers. For the sake of easy explanation, the only mobile apparatus that accesses the relay server 200 in the present embodiment will be one mobile telephone 100. Even in FIG. 1, no other mobile apparatuses are shown. Hereinafter, the information processing system 10 is explained on the assumption that only the mobile telephone 100 as a mobile apparatus shown in FIG. 1 accesses the relay server 200.

With the information processing system 10, various work requests or other information items such as registration of daily work reports are transmitted from the mobile telephone 100 to the work server 400, for example. Then, a response for expressing a work response to each request is returned from the work server 400. With the information processing system 10, various requests for operations management such as the registration of communications logs are transmitted from the mobile telephone 100 to the operations management server 500. Then, an operations management response for each request is returned from the operations management server 500. After that, the relay server 200 relays the exchange of requests or responses between the mobile telephone 100 and the work server 400, and between the mobile telephone 100 and the operations management server 500.

The mobile telephone 100 shown in FIG. 1 has a communications function, and generates various requests like those mentioned above and transmits them to the work server 400 or the operations management server 500. In other words, the function for realizing an embodiment of a communications apparatus in the present invention is incorporated into the mobile telephone 100. Also, a request corresponds to an example of an item of information as referred to in the present invention. Additionally, when the mobile telephone 100 transmits requests the mobile telephone 100 gathers a plurality of requests to generate a merged request and then transmits the merged request. When the merged request is generated, the mobile telephone 100 calculates the wait time necessary for the gathering of a plurality of requests using the method mentioned hereinafter.

When the relay server 200 receives the merged request transmitted by the mobile telephone 100, it divides the merged request into individual requests. The relay server 200 both passes the work requests of the divided requests to the work server 400 via the network 300 and passes the operations management requests of the divided requests to the operations management server 500 via the network 300 by the relay server 200. Also, the relay server 200 receives responses from the work server 400 or the operations management server 500, collects a plurality of responses to generate a merged response, and then transmits the merged response to the mobile telephone 100. This embodiment of the relay server 200 corresponds to an embodiment of a server apparatus in the present invention. The work server 400 and the operations management server 500 each combine the processing apparatus and processing part mentioned within the present invention. A system comprising the relay server 200, the work server 400, and the operations management server 500 corresponds to an example of a processing system described within the present invention. When a merged response is generated by the relay server 200, a wait time for the gathering of a plurality of requests is calculated according to the method mentioned hereinafter.

When the mobile telephone 100 receives a merged response from the relay server 200, it divides the merged response into individual responses, and then passes each response to the part that executes the corresponding process for each response.

When the work server 400 receives a work request from the relay server 200, the work server 400 creates a corresponding response to the work request and passes the corresponding response to the relay server 200. When the operations management server 500 receives an operations management request from the relay server 200, the operations management server 500 creates a corresponding response to the operations management request and passes the corresponding response to the relay server 200.

As explained in the overview above, with the information processing system 10 shown in FIG. 1, communications efficiency is improved by collectively exchanging the above-mentioned requests or responses.

Next, the hardware configuration of the mobile telephone 100 comprising the information processing system 10 is explained below.

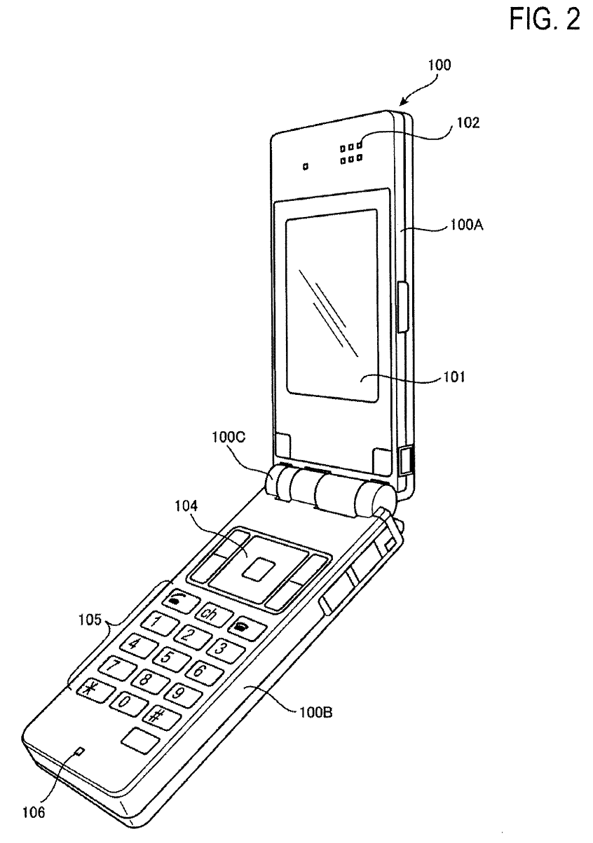

FIG. 2 is an external perspective view of the mobile telephone 100.

The mobile telephone 100 shown in FIG. 2 has an upper chassis 100A which is held against the ear of a user during conversations, a lower chassis 100B which is held in the user's hand, and a hinge 100C around which the upper chassis 100A and the lower chassis 100B are connected in a freely-foldable manner.

The upper chassis 100A has a liquid crystal panel 101 on which a menu screen or a photographic image is displayed, an internal speaker, and a slit 102 for emitting the sound from the speaker.

Also, the lower chassis 100B comprises a selection button 104 which is used for selecting each function or as the shutter button when shooting images, push buttons 105 for entering telephone numbers for example, an internal microphone, and a mouthpiece 106 for transferring a voice to the microphone.

The internal structure of the mobile telephone 100 is explained below.

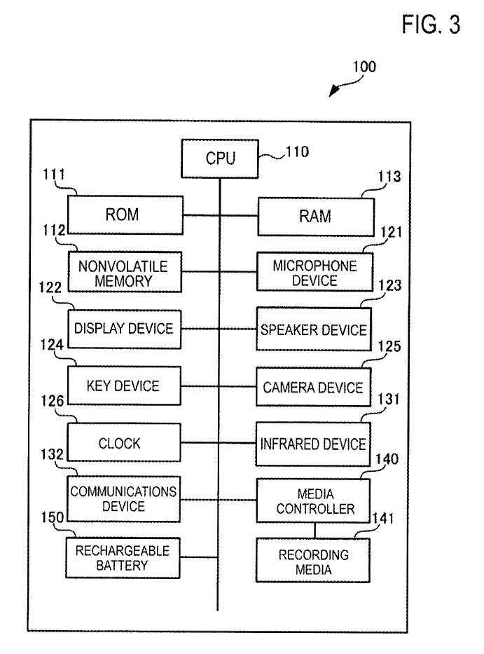

FIG. 3 is an internal block diagram of the mobile telephone 100.

The mobile telephone shown in FIG. 3 comprises a CPU 110 and ROM 111 which are mutually connected through a bus, nonvolatile memory 112, RAM 113, a microphone device 121, a display device 122, a loud-speaker device 123, a key device 124, a camera device 125, a clock 126, an infrared device 131, a communications device 132, a media controller 140, and a rechargeable battery 150.

The CPU 110 which executes each program controls the entire mobile telephone 100.

Each type of program executed by the CPU 110 and each constant required for the execution of each program are stored in ROM 111. The programs stored in ROM 111 are executed by the CPU 110 while using RAM 113 as the work area.

All types of information which could potentially be rewritten, i.e., address books or received e-mail, are recorded in nonvolatile memory 112.

The microphone device 121 includes a microphone for picking up a user's voice and a function block for processing the voice that was picked up by the microphone.

The speaker device 123 comprises a loud-speaker for outputting sound to the user and a function block for generating audio signals for driving the loud-speaker.

The camera device 125 is a function block by which image data is collected by the shooting of photographs. The display device 122 is a function block for controlling the images displayed on the liquid crystal panel 101 (see FIG. 2). The key device 124 is a function block for detecting each key operation made by the user. The clock 126 is a function block for showing the current time.

The media controller 140 reads data from a mounted recording medium 141 or writes to the recording medium 141 such as the image data generated by the camera device 125.

The infrared device 131 transmits an image or telephone number to a nearby external apparatus by infrared communication without passing through a predetermined base station.

Additionally, the communications device 132 actualizes communication functions in the mobile telephone 100. The mobile telephone 100 basically has devices such as those explained above.

An embodiment of the present invention in the information processing system 10 shown in FIG. 1 exchanges requests or responses between the mobile telephone 100 and the relay server 200. This function is focused on in the following explanation.

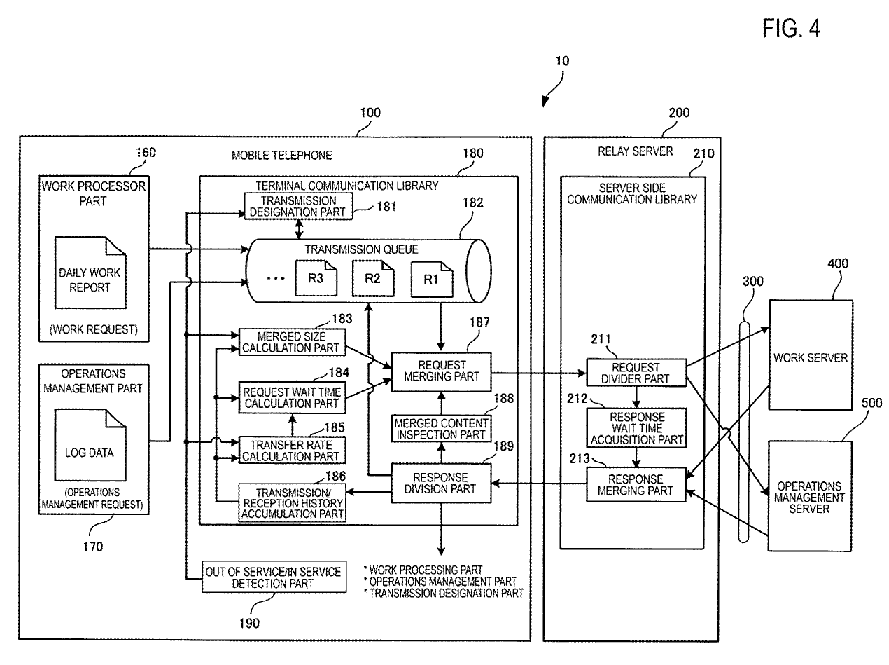

FIG. 4 is a function block diagram focusing on a function for exchanging requests or responses in the mobile telephone 100 and the relay server 200 within the information processing system 10 shown in FIG. 1.

First, the mobile telephone 100 has a work processing part 160, an operations management part 170, a terminal communication library 180, and an inside/outside detection part 190. The work processing part 160 executes work processing such as the creation of daily work reports. The operations management part 170 executes operations management processing such as the management of each log data. The terminal communication library 180 performs the transmission of requests or the reception of responses. The inside/outside detection part 190 detects whether the position of the mobile telephone 100 is outside or inside a communications area, according to the strength of radio waves received from the base station. The terminal communication library 180 corresponds to an embodiment of a communications apparatus according to the present invention. Furthermore, the terminal communication library 180 further has a transmission designation part 181, a transmission queue 182, a merged size calculation part 183, a request wait time calculation part 184, a transfer rate calculation part 185, a transmission/reception history accumulation part 186, a request merging part 187, a merged content inspection part 188, and a response division part 189. Here, the mobile telephone 100 handles telephone calls in addition to the above-mentioned components. However, the telephone call function has no relation to the essence of the present invention, so no figures or explanations are provided here.

The relay server 200 also has a server communications library 210. The server communications library 210 performs the transfer of requests to the work server 400 or the operations management server 500, or the reception of responses from these servers and the transfer thereof to the mobile telephone 100 through the network 300. The server communications library 210 further has a request divider 211, a response wait time acquisition part 212, and a response merging part 213.

Each element mentioned above is described below according to a continuous process flow from the generation of a request by the mobile telephone 100 to the sending of a corresponding response for that request from the relay server 200 to the mobile telephone 100.

First, a predetermined user operation is received by the mobile telephone 100 and a daily work report is created by the work processing part 160. Furthermore, a work request to register the daily work report in the work server 400 is generated. The request generated by the work processing 160 is passed to the terminal communication library 180. Then the request is stored in the transmission queue 182 of the terminal communication library 180. This transmission queue 182 corresponds to an example of a storage part according to the present invention.

In the present embodiment, the transmission designation part 181 monitors the detection results of the inside/outside detection part 190 and a storage state of the request sent to the transmission queue 182. Furthermore, there are also cases where this transmission designation part 181 monitors an elapsed time according to a designation from the request merging part 187 and the response division part 189. The elapsed time, the request merging part 187 and the response division part 189 will be explained hereinafter.

In the case that the transmission designation part 181 monitors the elapsed time, when both a condition that the elapsed time meets a retransmission interval mentioned hereinafter and a condition that a detection result of the inside/outside detection part 190 indicates that the mobile telephone 100 is inside a service area are satisfied, the transmission designation part 181 designates the starting of a transmission process comprising a continuous process like that explained below to each component of the terminal communication library 180. In other words, if the detection result of the inside/outside detector part 190 that the telephone 100 is inside the service area when the elapsed time meets the retransmission interval, the transmission designation part 181 designates the starting of the transmission process at the timing at which the elapsed time met the retransmission interval. If the detection result of the inside/outside detection part 190 indicates that the telephone 100 is outside the service area when the elapsed time met the retransmission interval, the transmission designation part 181 designates the starting of the transmission process at the timing after the elapsed time met the retransmission interval at which the detection result of the inside/outside detection part 190 was switched from the outside of the service area to the inside of the service area. However, if the elapsed time is not monitored, the transmission designation part 181 designates the starting of the transmission process at the timing when the detection result of the inside/outside detection part 190 is switched from the outside of the service area to the inside the service area or when one request is stored in an empty transmission queue 182 and the detection result of the inside/outside detection part is inside of the service area. This transmission designation part 181 corresponds to an example of a transmission designation part according to the present invention.

When the starting of the transmission process is designated by the transmission designation part 181, the transmission process is executed as explained below.

First, the transfer rate calculation part 185 calculates the speed (transfer rate) at which the information issued from the relay server 200 is sent to the mobile telephone 100. This calculation is performed based on both the past transmission and reception history accumulated in the transmission/reception history accumulation part 186 and the intensity of radio waves from the base station 700 used by the inside/outside detection part 190. The calculated transfer rate is passed to the request wait time calculation part 184.

The request wait time calculation part 184 calculates the request wait time required for requests to gather in the transmission queue 182 by using the aforementioned past transfer rate. The request wait time calculation part 184 corresponds to an example of a wait time establishing part according to the present invention, and this request wait time corresponds to an example of information wait time according to the present invention.

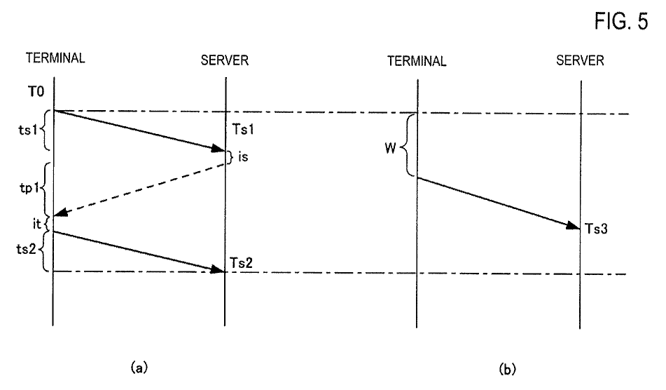

FIG. 5 is an explanatory diagram for explaining the calculation of the request wait time.

The request and response processes between a terminal and a server are tentatively shown in part (a) of FIG. 5. First, one request is sent to the server at the aforementioned start timing “T0”. A response to the request is received from the server by the terminal. The next request that was newly stored in the transmission queue 182 during that time is sent to the server by the terminal. In FIG. 4, the terminal is the mobile telephone 100 and the server is the relay server 200. In this process, the first request issued by the mobile telephone 100 at the start timing “T0” reaches the relay server 200 at “Ts1”, the first server arrival time after which the first to-server propagation time “ts1” has elapsed. Then, after the predetermined time “is” has elapsed, the relay server 200 acquires a response from the work server 400 or the operations management server 500. After that, the relay server 200 returns the acquired response to the mobile telephone 100. After the to-mobile telephone propagation time “tp1” has elapsed, the mobile telephone 100 has received a response. And after the predetermined preparation time “it” for the response process is spent, the mobile telephone 100 sends the second request. The second request arrives at the relay server 200 at the second to-server arrival time “Ts2”, which is after the second to-server propagation time “ts2” has elapsed.

The process that the terminal waits from start timing “T0” for a certain request wait time “W”, generates a merged request from two requests stored in the transmission queue 182 during that wait time, and sends the merged request to the relay server 200 is shown in part (b) of FIG. 5. In this case, the merged request sent by the mobile telephone 100, after the request wait time “W” from the start timing “T0” has elapsed, arrives at the relay server 200 at the third server arrival time “Ts3”, which is after the predetermined propagation time has elapsed.

If the third server arrival time “Ts3”, shown in part (b), is earlier than the second server arrival time “Ts2” shown in part (a), then communication efficiency is improved by generating the two requests. If the to-server propagation time is nearly the same time “ts” as the first request, second request, and merged request, then the difference in the two types of arrival times “Dt” is expressed in the following formula.

Dt=ts+is+tp1+it−W (1)

In the present embodiment, the request wait time “W” is calculated so this difference “Dt” will be longer than zero. The request wait time “W” for satisfying this condition is expressed in the following formula.

W<ts+tp1+is+it (2)

Furthermore, in the present embodiment, if both the predetermined time “is” for acquiring a response and the preparation time “it” for the mobile telephone 100 is to be seen as “0”, the request wait time “W” is calculated according to the following formula.

W<ts+tp1 (3)

If the request size is 1024 bits, the request transfer rate is 28.8 kbps, the response size is 1024 bits and the response transfer rate is 28.8 kbps for example, the request time “W” is shorter than 71 ms. Also, if the request size is 1024 bits, the request transfer rate is 64 kbps, the response size is 1024 bits and the response transfer rate is 384 kbps, then the request wait time “W” is shorter than 18.7 ms.

The request wait time is calculated by the request wait time calculation part 184 shown in FIG. 4 as explained below. First, the request wait time calculation part 184 refers and acquires a past request size and response size recorded in the transmission/reception history accumulation part 186, and then acquires the request transfer rate and the response transfer rate from the transfer rate calculation part 185. Then, the request wait time calculation part 184 calculates the to-server propagation time “ts” and the to-mobile telephone propagation time “tp1” and further calculates the request wait time by multiplying the summation of propagation time “ts” and “tp1” by a predetermined coefficient which is shorter than “1.0”. The calculated request wait time is reported to the request merging part 187.

In parallel to the calculation of this request wait time, the upper threshold of the merged request is calculated by the merged size calculation part 183. This upper threshold is the upper threshold for transmission sizes by the mobile telephone 100 and corresponds to an example of an upper threshold according to the present invention.

This upper threshold is calculated based on the past transmission and reception history accumulated in the transmission/reception history accumulation part 186 and the intensity of radio waves from the base station 700 used by the inside/outside detection part 190. The merged size calculation part 183 corresponds to an example in which an upper threshold determination part according to the present invention and a tracking part according to the present invention are combined.

The merged size calculation part 183 checks the intensity of radio waves from the base station 700 used by the inside/outside detection part 190 as the communication intensity in the information processing system 10. The communication intensity and the consecutive connection time, during which continuous communication between the mobile telephone 100 and the relay server 200 is possible, are seen as parameters for expressing the communication state in the information processing system 10. Here, the upper threshold of the merged size is calculated based on these parameters. The communication intensity herein is used as a standardized value that is between “0” and “1.0”.

Also, the consecutive connection time is the elapsed time after a connection was established between the mobile telephone 100 and the relay server 200. In the present embodiment, the most recent consecutive connection time in the past transmission/reception history is used as this consecutive connection time. Thus, if the aforementioned connection is severed, the time that has elapsed since the connection was re-established is used.

The merged size calculation part 183 calculates the upper threshold “s” of the merged size by using the consecutive connection time “t”, the communication intensity “w”, the basic size “S”, and the two predetermined constants “a” and “b” in the next formula.

s=a×w×(t+b)×S (4)

The basic size “S”, and the two predetermined constants “a” and “b” are not specified here. These values, determined in advance when the system is being designed, are stored in a predetermined memory. Note, the basic size “S” may also be determined based on 1500 bytes for example, which is the MTU (Maximum Transmission Unit) in Ethernet (registered trademark). As is evident in formula (4) above, the upper threshold “s” becomes smaller as both the consecutive connection time “t” and the communication intensity “w” become smaller. On the other hand, if the consecutive connection time “t” and the communication intensity “w” are small, it means that the connection between the mobile telephone 100 and the relay server 200 is likely to be severed. In other words, this upper threshold “s” becomes smaller as the connection is more likely to be severed.

The merged size calculation part 183 calculates the upper threshold, and reports the calculated upper threshold to the request merging part 187.

When transmission is designated from the transmission designation part 181, the request merging part 187 monitors the total size of the requests stored in the transmission queue 182. Then, the request merging part 187 waits during the request wait time reported from the request wait time calculation part 184.

In the present embodiment, it is possible that a new work request is sent to the transmission queue 182 while the request merging part 187 is waiting. Or it is possible that an operations management request, i.e., registration in the operations management server 500 of log data created during the operations management process, is sent to the transmission queue 182 from the operations management part 170. When the request merging part 187 does not accept any specific instruction from a merged content inspection part 188, it performs the following process. When either waiting has ended or the total size of the requests gathered in the transmission queue 182 exceeds the upper threshold, the request merging part 187 creates a merged request from the requests that were gathered in the transmission queue 182 at that time. Designations, etc. from the merged content inspection part 188 are hereinafter explained.

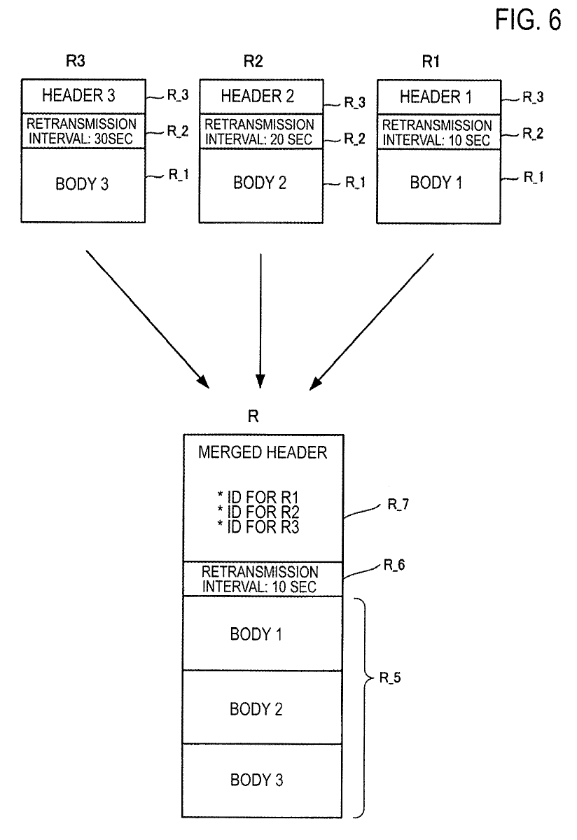

FIG. 6 is a schematic view showing an example of a merged request.

A merged request R including merged first through third requests R1, R2, and R3, is shown in FIG. 6. In this example, first, the request wait time “W” is calculated from formula (3) based on a comparison of the transmission time of two requests, including first request R1. Then, the three requests, first through third requests R1, R2, and R3, are gathered in the transmission queue 182 until request time “W” has elapsed. Each request comprises a body part R_1, a retransmission interval description part R_2, and a header part R_3. The content of a request is described in the body part R_1. The retransmission interval is described in the retransmission interval description part R_2 when retransmitting a request as hereinafter explained when no kind of response had been returned after the request was first transmitted. Predetermined header information, including the identifier (ID) added to the request, is described in the header part R_3.

The request merging part 187, shown in FIG. 4, constructs the merged body part R_5 by listing each body of multiple requests. Additionally, the request merging part 187 constructs a shortest retransmission interval description part R_6 by selecting the shortest transmission interval from the retransmission interval of each request. Then, the request merging part 187 constructs a merged header part R_7 by creating merged header information including the ID of each request. The request merging part 187, shown in FIG. 4, as well as transmitting the merged request R constructed herein to the relay server 200, also reports the merged request to the aforementioned transmission designation part 181 along with the aforementioned shortest retransmission interval. The request merging part 187 corresponds to an example of a transmission part according to the present invention.

If the transmission designation part 181 receives a report from the request merging part 187, it begins to monitor the elapsed time from that point on.

When a merged request is transmitted by a continuous process like that explained thus far, reduced communication efficiency from waiting a long period of time for requests to be gathered is avoided. Also, if the communication state is unstable, i.e., the connection is frequently severed, the aforementioned consecutive connection time might be short or the communication intensity might be weak. Therefore, the calculated upper threshold will be decreased, and the requests in the transmission queue 182 will be transmitted in a chopped up manner as a result. As a result, the number of requests transmitted at a time is decreased, but the certainty of the transmission can be increased.

The transmitted merged requests explained above are received by the request divider 211 in the server communications library 210 which exists in the relay server 200. The request divider 211 divides the merged request back into the original multiple requests by extracting the body part of each request from the received merged request. Furthermore, the request divider 211 analyzes the request which is expressed by each divided request. If a request was shown to be a work request in the analysis results, the request divider 211 transfers the request to the work server 400 and if a request was shown to be an operations management request, transfers the request to the operations management server 500. This request divider 211 corresponds to an example of a reception part according to the present invention.

Additionally, in the current embodiment, a merged request received by the request divider 211 is also passed to the response wait time acquisition part 212. First, the response wait time acquisition part 212 extracts the aforementioned shortest retransmission interval “tm” from the merged request. Then, the response wait time acquisition part 212 uses the shortest retransmission interval “tm” and the average arrival time “ts” at which a request issued by the mobile telephone 100 reaches the relay server 200 to calculate the response wait time “tr” according to the next formula.

tr<tm−ts−(ts×c) (5)

In this formula, “c” is a coefficient which expresses the ratio between the arrival time from the mobile telephone 100 to the relay server 200 and the arrival time from the relay server 200 to the mobile telephone 100. This coefficient is determined in advance when the system is being designed, and is stored in predetermined memory along with the aforementioned average arrival time “ts”. The arrival time from the mobile telephone 100 to the relay server 200 and the arrival time from the relay server 200 to the mobile telephone 100 are subtracted from the shortest retransmission time “tm” on the right side of formula (5). In other words, this is the upper limit of the response wait time allowed by the relay server 200. In the present embodiment, the final response wait time “tr” is obtained by multiplying this upper limit by a predetermined coefficient which is less than “1.0”. The response wait time acquisition part 212 reports this response wait time “tr” to the response merging part 213. This response wait time “tr” corresponds to an example of the response wait time according to the present invention.

The work server 400 creates, for example, a work response reporting the completed registration of a daily work report according to a work request. The operations management server 500 creates, for example, an operations management response reporting the completed registration of log data according to an operations management request. Each response is then sent to the response merging part 213. Here, the response merging part 213 receives the response wait time from the response wait time acquisition part 212. During the time from when the merged request is received by the request divider 211 until the response wait time has elapsed, the response merging part 213 generates a merged response by merging the responses sent from the work server 400 or the operations management server 500. This response merging part 213 corresponds to an example of the response acquisition part combined with the reply part according to the present invention.

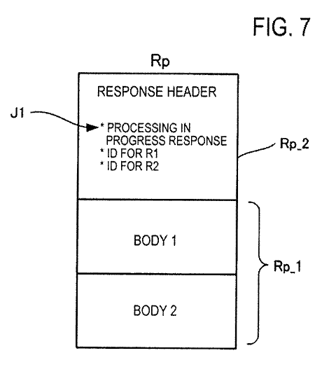

FIG. 7 is a schematic view of an example merged response.

A merged response Rp comprises a response body part Rp_1 and a response header part Rp_2. The response body part Rp_1 stores the body, i.e., the content, of each response. The response header part Rp_2 stores the request ID corresponding to the body of each response stored in the response body part Rp_1.

Here, there are cases where some of the responses for each of the multiple requests expressing a merged request that was originally sent to the relay server 200 have not yet reached the response merging part 213 after the response wait time has elapsed. In that case, processing in progress response J1, which indicates that response processing is still in continuation, is described in the response header part Rp_2. This processing in progress response J1 corresponds to an example of a processing in progress response according to the present invention. The merged response Rp shown in the example in FIG. 7 is two responses merged corresponding to the second and third requests from the first through third requests shown in FIG. 6. Therefore, in addition to each ID for the second and third requests being described in the response header part Rp_2, the processing in progress response J1, which indicates that response processing of one remaining request is still continuing, is described.

When the response merging part 213, shown in FIG. 4, creates such a merged response, it transmits the merged response to the mobile telephone 100.

This merged response is always returned based on the response acquired during the response wait time calculated in the aforementioned formula (5) before the merged request is retransmitted from the mobile telephone 100 in its current form. Therefore, unnecessary retransmission by the mobile telephone 100 is avoided, and it has become possible to avoid reduction of communication efficiency.

The merged response that was created and returned in this manner is received by the response division part 189 in the terminal communication library 180 of the mobile telephone 100.

The response division part 189 extracts the bodies of multiple responses from the response body part of the received merged response. The response division part 189 extracts the ID of the requests corresponding to each response from the response header. Then, from among the requests stored in the transmission queue 182 at that time, the response division part 189 recognizes requests that were the origin of each response extracted from the response body part based on their request ID and removes them. Additionally, the response division part 189 passes each response that corresponds to a work request to the work processing part 160 along with the corresponding request ID. If a response corresponds to an operations management request, the response division part 189 passes the response to the operations management part 170 along with the corresponding request ID. This response division part 189 is an example of a combined response reception part and removing part according to the present invention.

When the responses being currently processed are included in the response headers, the response division part 189 extracts responses being currently processed and passes them to the merged content inspection part 188. On the other hand, if all responses were acquired for the merged requests without including in the response header the responses being currently processed, the response division part 189 instructs the transmission designation part 181 to stop the monitoring of the elapsed time from when the merged request was transmitted. If there was a stop designation from the response division part 189, the transmission designation part 181 stops monitoring the elapsed time relating to this merged request. Then, the transmission designation part 181 enters into an inspection of a new transmission designation according to the detection result of the inside/outside detection part 190 and the request storage state in the transmission queue 182.

When a response being currently processed is passed to the merged content inspection part 188, it provides a hereinafter explained designation to the request merging part 187. This merged content inspection part 188 corresponds to an example of a retransmission part according to the present invention.

Next, if the retransmission interval described in the shortest retransmission interval description part of the merged request has elapsed after the merged request was transmitted, the aforementioned transmission designation part 181 designates the starting of transmission processing in relation to each structural element of the terminal communication library 180. The request wait time and the upper threshold of the merged size are therefore calculated at that time. Then, the request merging part 187 begins to generate a new merged request when the request wait time has elapsed or when the size of the request in the transmission queue 182 has reached the upper threshold value.

Here, if the merged content inspection part 188 receives a response being currently processed from the request division part 189, a designation in relation to the request merging part 187 is made as follows. When a new merged request is generated, the merged content inspection part 188 designates removal of the body part description of a request that is indicated by the response being currently processed as being in progress. If a designation such as this was made by the merged content inspection part 188, the request merging part 187 describes the request ID of the request from which the designation originated in the merged header part of the new merged request.

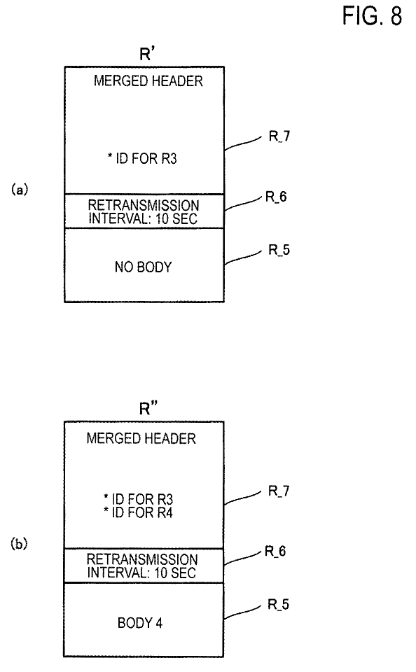

FIGS. 8A and 8B show an example of a new merged request.

The new merged requests shown in FIGS. 8A and 8B are created in accordance to a merged response Rp shown in FIG. 7. An example of a new merged request R′ comprising only a request to be retransmitted is shown in FIG. 8A. An example of a new merged request R″ comprising a request to be retransmitted and a request newly sent to the transmission queue 182 is shown in FIG. 8B.

In the case of the merged request R′ shown in FIG. 8A, only the ID of the request that was designated by the merged content inspection part 188 is described in a merged head part R_7. The previous shortest retransmission interval is described in its current form in the shortest retransmission interval description part R_6, and a merged body part R_5 is empty. The relay server 200, by which such the merged request was received, continues working to acquire a response which corresponds to the ID described in the merged request. In addition, the relay server 200 again starts counting the response wait time from the time this new merged request was received.

On the other hand, in the case of the merged request R″ shown in FIG. 8B, the ID of the newly merged request R4 is described in the merged head part R_7 in addition to the ID of the request that was designated by the merged content inspection part 188. The retransmission interval, which is the shorter of the previous shortest retransmission interval or the retransmission interval of the new request R4, is described in the shortest retransmission interval description part R_6. The body part of the new request R4 is described in the merged body part R_5. Also, the relay server 200, which received such a merged request, continues working to acquire a response for a request comprising only an ID while transferring the new request with a description in the body part to the work server 400 or the operations management server 500.

As explained thus far, in the present embodiment, a request to which the relay server 200 could not acquire a response in time is reported to the mobile telephone 100 as still being processed. Thus, in the present embodiment, it is known whether the transmission to the relay server 200 of a request to which no response was returned had failed or whether the request is still being processed by the relay server 200. As a result, it is possible to only describe the ID of a request in a new merged request. Accordingly, the increase in the size of the information resulting from the retransmission of the new merged request is negligible and an unnecessary amount of information does not have to be sent.

As explained above, gathering multiple requests or multiple responses according to the present embodiment has the effect of improving communication efficiency. Additionally, waiting for an unnecessarily long period of time for this information to be gathered can be avoided and reduced communication efficiency resulting from this waiting is thus curtailed. Furthermore, in the case of the present embodiment, sending an unnecessarily large amount of information can be avoided since only the IDs of requests currently being handled by the response process and the IDs of requests remaining after the retransmission time has elapsed is sent and reductions in the communication efficiency can also be kept in check from a perspective of the amount of information.

Note, the mobile telephone 100 was given above as an example of an embodiment of a communications apparatus according to the present invention, but the present invention is not hereby limited. A communications apparatus according to the present invention may also be a variety of mobile apparatuses, i.e., a mobile computer having a wireless communication function.

Additionally, the information processing system 10 by which the mobile telephone was used was given above as an example of an embodiment of an information processing system according to the present invention, but the present invention is not hereby limited. A communication apparatus according to the present invention may also be a wireless LAN system, i.e., a mobile computer having a wireless communication function.

Also, the merged size calculation part 183, having parameters for expressing the communication state in terms of the intensity of the radio waves used for communication and the consecutive connection time during which continuous communication is possible, was given above as an example of a tracking part according to the present invention, but the present invention is not hereby limited. A tracking part according to the present invention may be interpreted as a parameter, which expresses the communication state using the number of times counted transmission or reception failed from the past transmission/reception history.

What is claimed is:

1. A communications apparatus for transmitting one or more items of information to a processing system which performs predetermined processes using the information, said communications apparatus comprising:
a storage part which stores the items of information every time an item of information is provided;
a transmission designation part which designates the transmission of the items of information;
a transmission part which, upon receiving a transmission designation from the transmission designation part, waits for an information wait time, then collectively transmits the items of information stored during the information wait time, to the processing system; and
a wait time determining part which obtains a first time required for collectively transmitting both the items of information stored at the time designated by the transmission designation part and the items of information stored during the information wait time, and a second time required for individually transmitting both the items of information stored at the time designated by the transmission designation part and the items of information provided to the storage part afterwards in order to transmit all stored information to reach the processing system, compares the first time with the second time, and thereby sets a shorter of the two times as the information wait time in the transmission part.

2. The communications apparatus according to claim 1, said communications apparatus further comprising:
a tracking part which tracks how likely it is that communication between said communications apparatus and said processing apparatus will be severed; and
an upper threshold determination part which, based on the likelihood of communication being severed, determines the upper threshold of the size of information collectively transmitted by said transmission part, the upper threshold decreasing as communication is more likely to be severed;
wherein said transmission part, even at a point in time before said information wait time has elapsed, starts collectively transmitting information stored up until said point in time if the size of information stored up until that point in time has reached said upper threshold.

3. The communications apparatus according to claim 1, further comprising:
a response reception part which receives results responses returned from said processing system; and
a removing part which removes from said storage part the information corresponding to the results response received by said response reception part;
wherein said processing system performs said predetermined process using the information transmitted from said communications apparatus, generates said results response for expressing the process results, and returns said results response to said communications apparatus.

4. The communications apparatus according to claim 1, said communications apparatus further comprising:
a response reception part which receives results responses which are collectively returned from said processing system; and
a response reply part which returns each results response collectively received by said response reception part such that each piece of information corresponding to each results response is individually returned to each predetermined information source provided to said storage part; wherein
said storage part which receives each item of information from each predetermined information source;
said processing system further including:
a first part which receives each item of information collectively transmitted from said communications apparatus;
a second part which individually performs said predetermined processing on said each item of information;
a third part which generates a results response for each item of information, said results response expressing the processing result of said predetermined process; and
a fourth part which collectively returns these results responses to said communications apparatus.

5. An information processing system comprising:
a processing system for performing predetermined processes using items of information; and
a communications apparatus for transmitting said items of information to said processing system; wherein said communications apparatus includes:
a storage part which, every time one of said information items is provided, stores said information item;
a transmission designation part which designates the transmission of said items of information;
a transmission part which, upon receiving a designation of items of information from said transmission designation part, waits for an information wait time established in advance, then collectively transmits to said processing system the information items stored in said storage part until after the information wait time has ended; and
a wait time establishing part which establishes in said transmission part an information wait time such that the time required for all information items to reach said processing system is shorter in the case of the information wait time resulting when waiting only for said information wait time and collectively transmitting the stored information, than in the case for the information wait time resulting when individually transmitting the information stored when said transmission designation part has designated a transmission and when transmitting the information items provided to said storage part without waiting for said information wait time;
said processing system further includes:
a reception part which receives information items transmitted from said communications apparatus; and
a processing part which performs said predetermined processes using the information items received from said reception part.

6. A server apparatus comprising:
a reception part which receives one or more items of information from a communications apparatus which transmits said information items to acquire a results response for expressing the processing results of predetermined processes performed using said information items;
a response reception part which relays information items received by said reception part to a processing apparatus that performs predetermined processes and receives said results responses;
a reply part which returns to said communications apparatus the results response received by said response reception part; and
an alternate reply part which, when said response reception part can not receive said results response even after a predetermined response wait time has elapsed after said information item was received by said reception part, instead of returning the said results response from said reply, returns a processing in progress response to said communications apparatus which expresses that said predetermined process is still continuing.

7. The server apparatus according to claim 6, wherein
said communications apparatus retransmits said information items when said results response was not acquired even if a predetermined retransmission wait time has elapsed after said information was transmitted, and
said alternate reply part which returns said process in progress response in a format recognized by said communications apparatus as one type of said results response.

8. The server apparatus according to claim 6, wherein
said communications apparatus retransmits said information items when said results response was not acquired even if a predetermined retransmission wait time has elapsed after said information was transmitted, and
said alternate reply part adopts as said response wait time a time at which said process in progress response reaches said communications apparatus before said retransmission wait time has elapsed at said communications apparatus.

9. The server apparatus according to claim 6, said server apparatus further comprising:
said reception part which receives said information items in addition to receiving a retransmission wait time attached to said information items; and
said alternate reply part which uses as said response wait time a time which is shorter than the retransmission wait time received by said reception part; wherein
said communications apparatus, when said results response was not acquired even after a predetermined retransmission wait time has elapsed after said information was transmitted, retransmits said information items in addition to attaching said retransmission wait time to said information items when transmitting said information.

10. The server apparatus according to claim 6, wherein
said reception part receives information items collectively transmitted from said communications apparatus;
said response reception part expresses each item of information collectively received by said reception part to each processing apparatus for performing a predetermined process corresponding to each said item of information, and which individually receives said results responses for each said item of information; and
said reply part which collectively returns to said communications device the results responses which were individually received by said response reception part;
wherein
said communications apparatus, having been provided with said information, waits only for the information wait time which was established in advance, and collectively transmits the information items stored up to the point in time after said communications apparatus stopped waiting.

11. The server apparatus according to claim 6, wherein
said alternate reply part returns as said process in progress response in a format recognized by said communications apparatus as one type of said results response;
said communications apparatus, when said processing in progress response is returned during said retransmission wait time, changes retransmission to said information after said retransmission wait time has elapsed, thereby transmitting alternate information having a smaller transmission size than the indicated said information; and
said alternate reply part returns said process in progress response to said communications apparatus if a results response corresponding to the information indicated by said alternate information by said response reception part was not received even after said response wait time from when said alternate information was received by said reception part has elapsed; wherein
said communications apparatus retransmits said information items when said results response was not acquired even if the predetermined retransmission wait time from when said information was transmitted has elapsed.

12. An information processing system comprising:
a server apparatus including;
a reception part which receives one or more items of information from a communications apparatus for transmitting said items of information in order to acquire a results response which expresses the processing results of a predetermined process performed using the information,
a response reception part which receives said results response and sends the items of information received from said reception part to a processing apparatus which performs said predetermined process,
a reply part which returns the results response received by said response reception part to the communications apparatus, and
an alternate reply part which, when said results response was not received by said response reception part even after said items of information were received by the reception part and the predetermined response wait time had elapsed, changes said results response from said reply part then returns a processing in progress response for expressing that said predetermined process is continuing,
the communications apparatus including;
a transmission part which transmits said items of information,
a response reception part which receives said results response or said processing in progress response, and
a retransmission part which retransmits said items of information to said transmission part when neither said results response nor said processing in progress response was received by said response reception part even after said transmission part transmitted said items of information when the predetermined retransmission wait time had elapsed.
